(19) United States
(12) Patent Application Publication
(10) Pub. No.: US 2025/0245812 A1
(43) Pub. Date: Jul. 31, 2025

(54) METHOD FOR AUTOMATICALLY DETECTING DEFECTS IN ASSEMBLY UNITS

(71) Applicant: Instrumental, Inc., Los Altos, CA (US)

(72) Inventors: Samuel Bruce Weiss, Los Altos, CA (US); Reilly Elizabeth Hayes, Los Altos, CA (US); Nicolas Weidinger, Los Altos, CA (US); Samuel Louis Warren, Los Altos, CA (US); David Rowe Garver, Los Altos, CA (US); Rustem Feyzkhanov, Los Altos, CA (US); Vlad Orlenko, Los Altos, CA (US); Prerna Dhareshwar, Los Altos, CA (US)

(21) Appl. No.: 19/036,775

(22) Filed: Jan. 24, 2025

Related U.S. Application Data
(60) Provisional application No. 63/624,730, filed on Jan. 24, 2024.

(51) Int. Cl. G06T 7/00; G06T 7/11; G06T 7/50; G06T 7/62; G06V 10/44; G06V 10/74; G06V 20/70

(52) U.S. Cl. CPC G06T 7/0006; G06T 7/001; G06T 7/11; G06T 7/50; G06T 7/62; G06V 10/44; G06V 10/761; G06V 20/70

(57) ABSTRACT

A method includes: accessing an initial image depicting a verified assembly unit; and detecting an initial constellation of features in the initial image. The method further includes: accessing a first image depicting an unverified assembly unit; detecting a first constellation of features in the first image; characterizing differences between corresponding features in the initial constellation of features and the first constellation of features; identifying a first dimension of a first feature of interest exhibiting a first difference exceeding a threshold difference; receiving manual verification the first feature of interest from the first constellation of features, the first dimension offset from a target dimension of the first feature of interest from the initial constellation of features; and defining a first nominal feature range for the first feature of interest, the range bounded by the first dimension and the target dimension.

### CROSS-REFERENCE TO RELATED APPLICATIONS

This application claims the benefit of U.S. Provisional Application No. 63/624,730, filed on 24 Jan. 2024, which is hereby incorporated in its entirety by this reference.

This Application is related to U.S. patent application Ser. No. 15/653,040, filed on 18 Jul. 2017, Ser. No. 15/953,206, filed on 13 Apr. 2018, and Ser. No. 16/506,905, filed on 9 Jul. 2019, each of which is incorporated in its entirety by this reference.

### TECHNICAL FIELD

This invention relates generally to the field of optical inspection and more specifically to a new and useful method for automatically detecting defects in assembly units in the field of optical inspection.

### BRIEF DESCRIPTION OF THE FIGURES

FIG. 1 is a flowchart representation of a method;

FIG. 2 is a flowchart representation of the method;

FIG. 3 is a flowchart representation of the method;

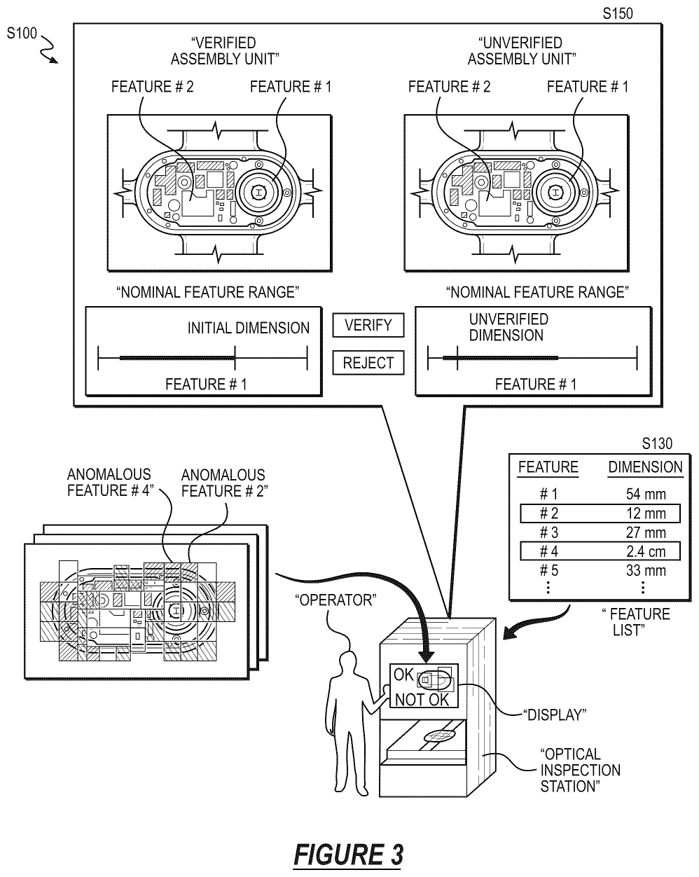

FIG. 4 is a flowchart representation of the method; and

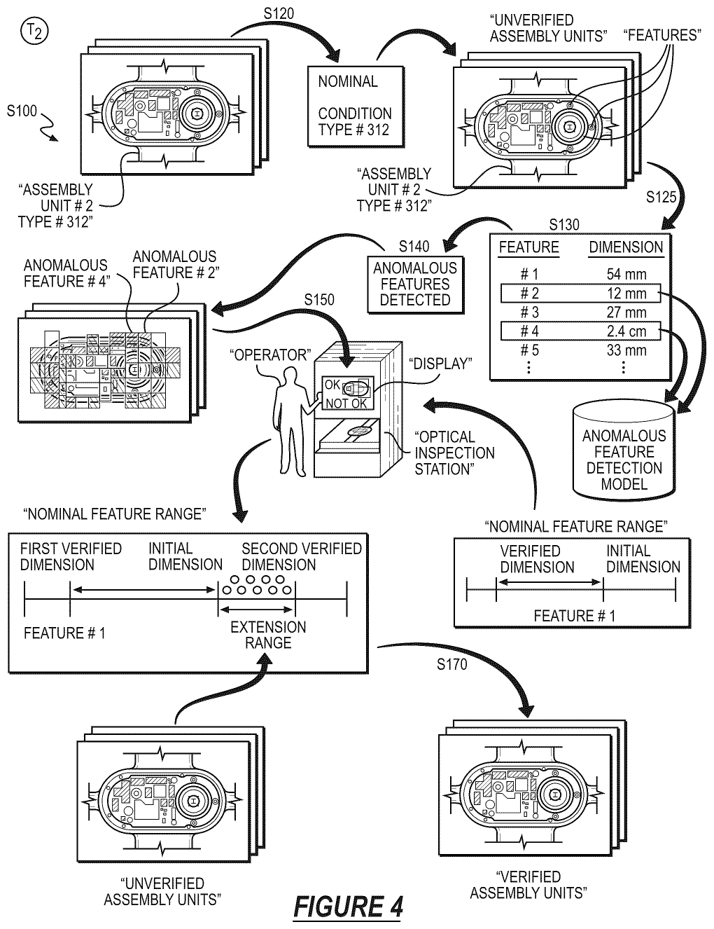

FIG. 5 is a flowchart representation of the method.

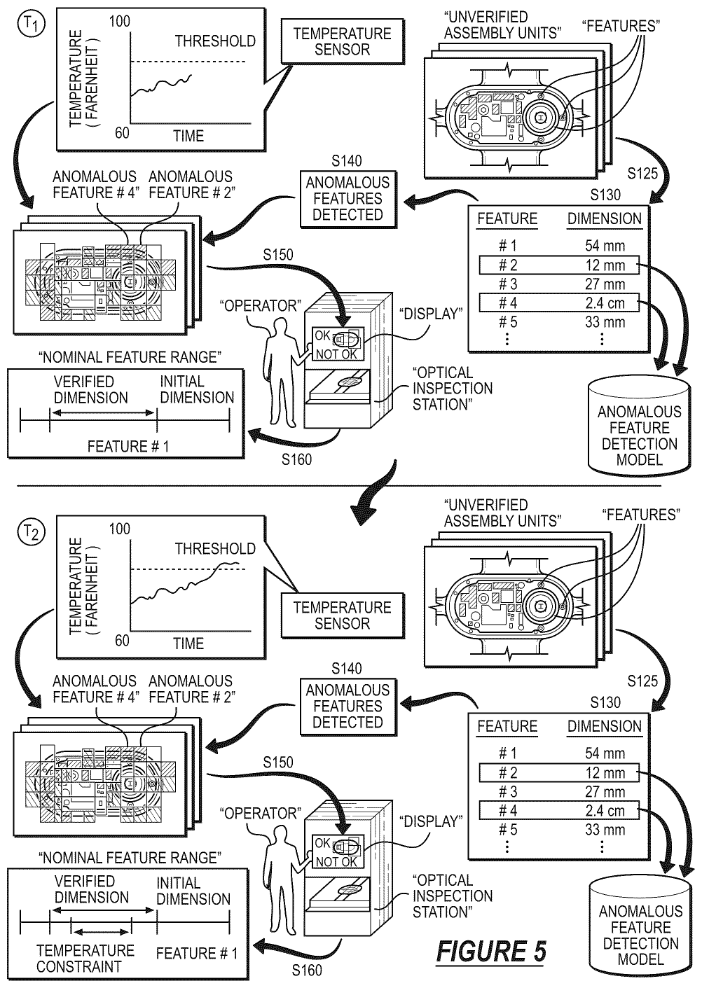

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHOD

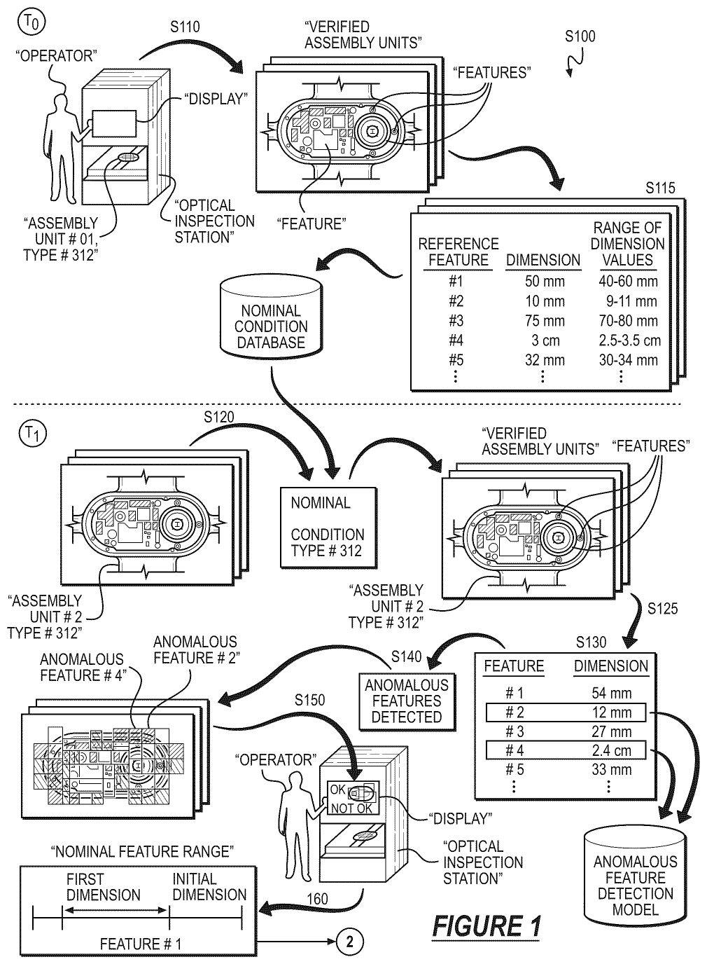

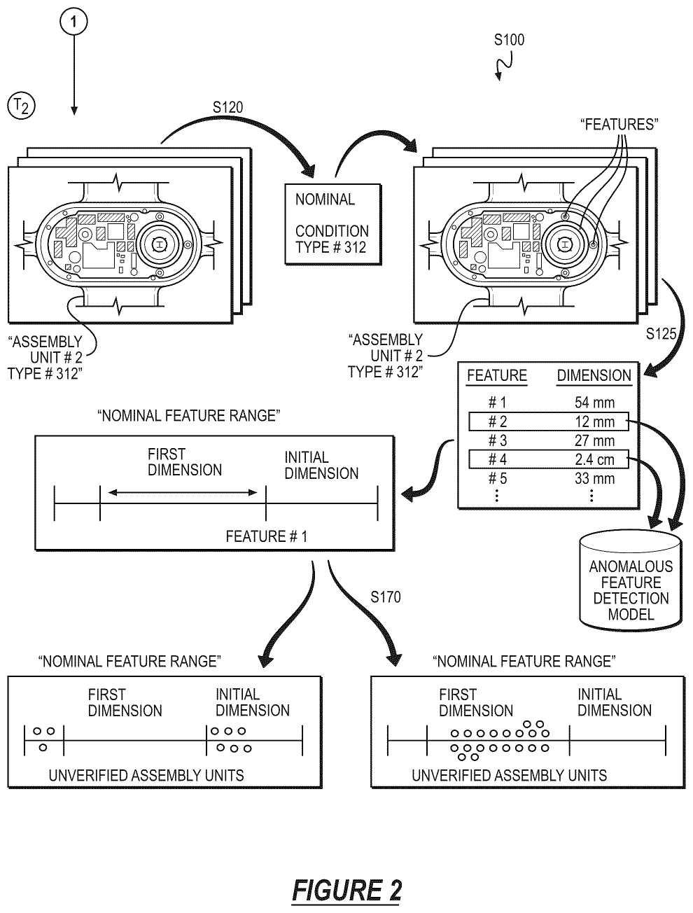

As shown in FIGS. 1 and 2, a method S100 for automatically detecting defects in assembly units includes: accessing an initial image depicting a verified assembly unit at a particular assembly stage in Block S110; and detecting an initial constellation of features, in the initial image, representing physical features exhibited by the verified assembly unit in Block S115.

The method S100 also includes, during a first assembly period: accessing a first image captured at an optical inspection station and depicting a first unverified assembly unit at the particular assembly stage in Block S120; detecting a first constellation of features, in the first image, representing physical features exhibited by the first unverified assembly unit in Block S125; and characterizing differences between dimensions of features in the first constellation of features and corresponding dimensions of features in the initial constellation of features exhibited in the initial verified assembly unit in Block S130.

The method S100 further includes, during the first assembly period: identifying a first dimension of a first feature of interest, in the first constellation of features, distinct from a first verified dimension of the first feature of interest in the initial constellation of features in Block S140; and rendering a first visual representation of the first unverified assembly unit on a display at the optical inspection station, the first visual representation indicating the first feature of interest on the first unverified assembly unit in Block S150.

The method S100 also includes, during the first assembly period and in response to receiving manual verification of the first feature of interest on the first unverified assembly unit at the optical inspection station, defining a first verified feature range of the first feature of interest in Block S160. The first verified feature range is bounded by the first dimension of the first feature of interest and the first verified dimension of the first feature of interest extracted from the initial image.

The method S100 further includes, during a second assembly period following the first assembly period: accessing a second image captured at the optical inspection station and depicting a second unverified assembly unit at the particular assembly stage in Block S120; and detecting a second constellation of features, in the second image, representing physical features exhibited by the second unverified assembly unit in Block S125.

The method S100 also includes, during the second assembly period, extracting a second dimension of the first feature of interest, in the second constellation of features, from the second image in Block S140; and, in response to the second dimension of the first feature of interest falling within the first verified feature range, verifying the first feature of interest depicted in the second unverified assembly unit in Block S170.

### 2. APPLICATIONS

Generally, the method S100 can be executed by a local or remote computer system (hereinafter the “computer system”): to aggregate digital photographic inspection images of assembly units, of a particular assembly type, recorded by an optical inspection station during production of the assembly units; to automatically identify physical features (e.g., parts, components, corners, edges, surfaces, surface profiles, geometries, relative positions, relative orientations) exhibited on assembly units from inspection images of these assembly units; to extract feature constellations representing these physical features from these inspection images; to present feature constellations to an operator to confirm these feature constellations correspond to a predicted functional assembly unit; and to define a nominal feature range representing acceptable dimension values or feature constellations based on these confirmed features.

More specifically, the computer system can: access an image of a first assembly unit captured by the optical inspection station; detect a quantity of (e.g., three) largest features in the image; annotate features in the image; render the image within a display of the optical inspection station; prompt the operator to confirm that this quantity of features corresponds to a predicted functional assembly unit of the particular assembly stage; and define an initial representation of feature ranges based on these confirmed features. The computer system can then: access a second image of a second assembly unit captured by the optical inspection station; detect the quantity of (e.g., three) features in the second image, confirmed by the operator as corresponding to the functional assembly unit; detect a new quantity of (e.g., next three largest features) in the second image; render the second image within the display of the optical inspection station; prompt the operator to confirm this new quantity of features corresponds to the functional assembly unit; and update the nominal feature range based on these new confirmed features.

The computer system repeats these methods and techniques over a period of time (e.g., one day, one week, one month) to redefine the nominal feature range as corresponding to predicted functional parts or components of the predicted functional assembly unit. Further, the computer system can redefine the nominal feature range as corresponding to predicted defective parts or components of a predicted defective assembly unit.

Additionally or alternatively, the computer system can present the annotated images, captured by the optical inspection station, to an engineer and similarly prompt the engineer to annotate and confirm these features as corresponding to predicted functional assembly units at the particular assembly stage in order to remotely define the nominal feature range.

Furthermore, the computer system can load this nominal feature range onto an optical inspection station succeeding this assembly stage. The optical inspection station can then capture an image of the assembly unit upon completion of this assembly stage and implement machine learning, artificial intelligence, or other computer vision techniques to automatically verify that the assembly unit exhibits visual characteristics that fall within the nominal range of features. Responsive to detecting visual characteristics exhibited on the assembly unit that fall outside of the nominal feature range (i.e., the assembly unit is defective), the optical inspection station flags the assembly unit in real time. Accordingly, the operator may then discard the defective assembly unit, thereby avoiding further time and component investment into assembly of the defective assembly unit or send the defective assembly unit for rework to realign the defective assembly unit with the nominal feature range prior to passing the assembly unit to a next stage of assembly.

### 2.1 Anomalous Feature Detection

The computer system can further execute Blocks of the method S100: to identify anomalous features deviating from the nominal feature range; to rank these anomalous features by dimension value; to annotate (e.g., highlight, flag) inspection images of each assembly unit with the highest-ranked anomalous features; and to automatically present these annotated inspection images to an operator (e.g., an operator of an assembly line, a technician of an assembly line, an engineer), thereby enabling the operator to quickly inspect anomalous features representing defective assembly units that are still in production in order to selectively identify and remove assembly units for inspection prior to further production or shipment out of the facility.

In particular, the computer system can: can implement machine learning, machine vision, and/or other computer vision techniques to derive common feature detection models to detect reference features exhibited by assembly units of a particular assembly type based on patterns of constellations (or “groups”) of common features across sequences of inspection images over a period of time (e.g., one day, one production cycle, five production cycles). The computer system can also: detect anomalous features in inspection images of assembly units-such as features that deviate from common features or reference features defined in a corresponding nominal condition or features characterized by a dimension that falls outside of a nominal feature range. In one example, the computer system detects anomalous features that deviate from a nominal condition and identifies these anomalous features as defective parts or components (e.g., an antenna, a battery, a processor) of these assembly units. In another example, the computer system detects anomalous features that deviate from a nominal condition and identifies these anomalous features as visual defects on surfaces of these assembly units (e.g., a scratch, an indent, a foreign object, or debris). In yet another example, the computer system detects anomalous features that deviate from a nominal condition and identifies these anomalous features as non-visual defects of these assembly units (e.g., tool settings, adhesive types and application conditions, component batch identifiers, timestamped ambient data, or station operator identifiers) of these assembly units.

Furthermore, the computer system can: automatically rank these anomalous features, such as by dimension (e.g., size) of each feature; highlight corresponding regions of each inspection image depicting the highest-ranking anomalous features with colored markers or colored bounding boxes; generate a prompt for the operator to review these anomalous features and provide feedback of each anomalous feature; and serve these highlighted inspection images and the prompt within the application executing on the operator's device or through the display of the optical inspection station in real-time, thereby enabling the operator to timely review and focus inspection of the highest-ranking anomalous features representing defective parts or components of an assembly unit during each stage of production in order to remove assembly units for inspection prior to further production or shipment out of the facility.

Accordingly, the computer system can collect feedback regarding presence of the anomalous features in each inspection image based on visual inspection of the highlighted inspection images. Responsive to positive feedback of the highest-ranking anomalous features, the computer system can reinforce the anomalous feature detection model identifying the anomalous features exhibited by assembly units of a particular assembly type. Additionally or alternatively, responsive to negative feedback indicating the anomalous feature is not anomalous or is benign or normal, the computer system can: expand the nominal feature range representing this feature; update the nominal feature range representing values in the corresponding nominal condition within the nominal condition database; and mute detection of similar future anomalous features exhibited by similar assembly units of this particular assembly type.

### 2.2 Unsupervised Anomaly Detection

In one implementation, the computer system can: access a set of images and depicting unverified assembly units previously captured at the optical inspection station; and analyze dimensions of features within the constellations of features to define a nominal feature range representing expected dimensional variations across the unverified assembly units. In this implementation, the computer system can: implement machine learning, machine vision, and/or other computer vision techniques to analyze patterns across feature constellations detected in the set of unverified units; derive a nominal feature range by evaluating distributions of feature dimensions and identifying consistent patterns within the unverified data; detect anomalies by identifying feature dimensions that deviate beyond statistically inferred thresholds without relying on prior operator feedback; and flag detected anomalies for further inspection.

For example, the computer system can reject outliers by implementing traditional statistical outlier rejection methods, such as: interquartile range (IQR) analysis to exclude feature dimensions falling outside the upper and lower bounds of the feature distribution; and z-score evaluation to identify feature dimensions that deviate beyond a predefined number of standard deviations from the mean feature value. In another example, the computer system can compute a nominal feature range from standard statistical descriptors, such as by: calculating the mean dimension of a feature across unverified assembly units to establish a central reference value; and deriving a standard deviation to define an acceptable tolerance range around the mean, thereby capturing natural variations while excluding potential anomalies.

In yet another example, the computer system can: derive a nominal feature range based on the distribution of feature dimensions extracted from constellations of features detected across unverified assembly units, such as by: analyzing the distribution of feature dimensions to detect skewness, kurtosis, and multimodal patterns; and applying a combination of statistical methods, such as density-based clustering and percentile-based thresholding, to define feature boundaries that account for underlying distribution characteristics.

In yet another example, the computer system can derive a nominal feature range by applying a multivariate approach to analyze feature dimensions extracted from constellations of features detected across unverified assembly units, such as by: constructing a multi-dimensional manifold representing relationships between multiple feature dimensions, such as geometric alignments, surface textures, and positional tolerances; and identifying normal feature ranges within the manifold by evaluating clusters of feature dimensions that exhibit consistent spatial relationships and statistical coherence across the unverified assembly units. In this example, the computer system can then: condense the multi-dimensional manifold-representing relationships between feature dimensions extracted from constellations of features detected across unverified assembly units-into a single scalar anomaly score, such as by projecting feature dimensions onto the manifold to derive a scalar representation indicative of feature normality or deviation and aggregating contributions from multiple feature dimensions to define a unified measure of deviation from expected patterns; and characterize the scalar anomaly score based on advanced statistical descriptors, such as higher-order moments, percentile-based thresholds, and distribution fitting techniques, to refine the nominal feature range and refine anomaly detection accuracy across unverified assembly units.

Therefore, the computer system can identify novel defects in real-time by: autonomously analyzing feature dimensions extracted from constellations of features across unverified assembly units without prior operator feedback; and dynamically refining nominal feature ranges based on statistical patterns and multivariate relationships.

### 2.3 Zero-Shot Anomaly Detection

In one implementation, the computer system can: analyze feature dimensions of an initial assembly unit captured at the optical inspection station without prior exposure to previously inspected units; and detect anomalies in the first assembly unit by leveraging a pre-trained anomaly detection model trained on historical anomaly data collected from similar assembly processes. In this implementation, the computer system can: implement machine learning techniques to apply generalized feature detection models, pre-trained on diverse anomaly patterns observed across various assembly unit types; identify deviations in feature dimensions by comparing detected feature characteristics against pre-defined nominal feature ranges encoded within the anomaly detection model; and flag feature dimensions exhibiting deviations from the pre-defined nominal feature ranges for further inspection, thus identifying potential defects in the first inspected assembly unit.

For example, the computer system can: analyze feature dimensions of an initial assembly unit, such as component alignments, hole placements, and surface textures, captured at the optical inspection station without prior exposure to previously inspected units; apply a pre-trained anomaly detection model—trained on historical data from similar assembly processes—to identify deviations in feature dimensions, such as misalignments exceeding pre-defined tolerances or surface defects inconsistent with known patterns; and flag the identified deviations for operator review at the optical inspection station, facilitating immediate assessment and corrective action for the initial assembly unit.

Therefore, the computer system can: detect anomalous features in a new instance of an assembly unit by analyzing feature dimensions without requiring prior inspection images of the unit; and leverage pre-trained models to identify deviations from expected feature characteristics to detect early-stage defects, such as during quality control for first-time production runs or prototype evaluations.

### 3. SYSTEM

Blocks of the method S100 can be executed by a computer system, such as: locally on an optical inspection station (as described below) at which inspection images of assembly units are recorded; locally near an assembly line populated with optical inspection stations; within a manufacturing space or manufacturing center occupied by this assembly line; or remotely at a remote server connected to optical inspection stations via a computer network (e.g., the Internet), etc. The computer system can also interface directly with other sensors arranged along or near the assembly line to collect non-visual manufacturing and test data or retrieve these data from a report database associated with the assembly. Furthermore, the computer system can interface with databases containing other non-visual manufacturing data for assembly units produced on this assembly line, such as: test data for batches of components supplied to the assembly line; supplier, manufacturer, and production data for components supplied to the assembly line; etc.

The computer system can also interface with an operator (e.g., an engineer, an operator, an assembly line worker) via an operator portal-such as accessible through a web browser or native application executing on a laptop computer or smartphone—to serve prompts and notifications to the operator and to receive defect labels, anomaly feedback, or other supervision from the operator.

The method S100 is described below as executed by the computer system: to map a relationship between visual and non-visual features for an assembly type in time and space; to leverage these relationships to derive correlations between defects detected in assembly units of this type and visual/non-visual data collected during production of these assembly units; and to leverage these relationships to correlate visual anomalies in assembly units to non-visual root causes (and vice versa) based on visual and non-visual data collected during production of these assembly units. However, the method S100 can be similarly implemented by the computer system to derive correlations between visual/non-visual features and anomalies/defects in singular parts (e.g., molded, cast, stamped, or machined parts) based on inspection image and non-visual manufacturing data generated during production of these singular parts.

### 4. OPTICAL INSPECTION STATION AND INSPECTION IMAGES

The computer system accesses a set of images recorded by an optical inspection station during production of assembly units. For example, the computer system can retrieve a set of images directly from the optical inspection station, such as in real-time when an inspection image of an assembly unit is recorded by the optical inspection station during production of the assembly unit. The computer system can additionally or alternatively, retrieve a set of images recorded by an optical inspection station, uploaded from the optical inspection station to a file system (e.g., a database) via a computer network, and stored in a database.

As described in U.S. patent application Ser. No. 15/653,040, filed on 18 Jul. 2017, an optical inspection station can include: an imaging platform that receives a part or assembly; a visible light camera (e.g., a RGB CMOS, or black and white CCD camera) that captures images (e.g., digital photographic color images) of units placed on the imaging platform; and a data bus that offloads images, such as to a local or remote database. An optical inspection station can additionally or alternatively include multiple visible light cameras, one or more infrared cameras, a laser depth sensor, etc.

In one implementation, an optical inspection station also includes a depth camera, such as an infrared depth camera, configured to output depth images. In this implementation, the optical inspection station can trigger both the visible light camera and the depth camera to capture a color image and a depth image, respectively, of each unit set on the imaging platform. Alternatively, the optical inspection station can include optical fiducials arranged on and/or near the imaging platform. In this implementation, the optical inspection station (or a local or remote computer system interfacing with the remote database) can implement machine vision techniques to identify these fiducials in a color image captured by the visible light camera and to transform sizes, geometries (e.g., distortions from known geometries), and/or positions of these fiducials within the color image into a depth map, into a three-dimensional color image, or into a three-dimensional measurement space for the color image, such as by passing the color image into a neural network.

The computer system is described herein as including one or more optical inspection stations and generating a virtual representation of an assembly line including the one or more optical inspection stations. However, the computer system can additionally or alternatively include any other type of sensor-laden station, such as an oscilloscope station including NC-controlled probes, a weighing station including a scale, a surface profile station including an NC-controlled surface profile gauge, or a station including any other optical, acoustic, thermal, or other type of contact or non-contact sensor.

### 5. NOMINAL CONDITION

Blocks of the method S100 recite: accessing an initial image depicting a verified assembly unit at a particular assembly stage in Block S110; and detecting an initial constellation of features, in the initial image, representing physical features exhibited by the verified assembly unit in Block S115.

Generally, the computer system can access a nominal condition (e.g., a baseline condition, a target condition) for an assembly unit of a particular assembly type within the facility. The nominal condition defines: a set of reference features exhibited by an assembly unit; a nominal dimension of each reference feature; and a nominal feature range representing acceptable values for the dimension of each reference feature.

More specifically, the nominal condition defines: a set of reference features representing physical features exhibited by the assembly unit (e.g., a set of edges, an antenna, a battery, a processor); a nominal dimension of each reference feature (e.g., a size, a geometry, a length, a width, a height, a yaw angle, a pitch angle, a roll angle, an absolute position, or a relative position); and a nominal feature range representing acceptable real values for each dimension of each reference feature, such as a nominal feature range representing length between 5 millimeters and 10 millimeters or a nominal feature range representing size between 75 and 85 centimeters.

In one implementation, the computer system can: access a nominal condition, defined by the operator (e.g., an engineer, an operator of the assembly line, a technician) for each assembly type; and compile these nominal conditions for each assembly type into a nominal condition database.

In another implementation, the computer system can: access optical data associated with an assembly line of a particular assembly type, captured by the optical station over a particular duration of time (e.g., one day, one week, one month); implement machine learning and other computer vision techniques to manipulate these optical data to define a common set of features for the assembly unit, a dimension of each feature, and predict a nominal feature range representing acceptable values for each dimension of each feature; aggregate the common set of features, dimensions, and nominal feature ranges representing acceptable values of each dimensions into a nominal condition for each assembly type; and store these nominal conditions in the nominal condition database assigned to each assembly type.

### 5.1 Operator Defined Nominal Condition

In one implementation, the computer system can: access a nominal condition, defined by the operator (e.g., an engineer) for each assembly type; and compile these nominal conditions for each assembly type into a nominal condition database.

In one variation, the computer system can receive a nominal condition predefined by an operator (e.g., an engineer) for a particular assembly type. In particular, the operator may interface with an operator portal (e.g., a native or web application executing on a computing device accessed by the operator): to upload a set of inspection images depicting assembly units of a particular assembly type and annotated with reference features; to define a set of regions-of-interest or boundary boxes on each inspection image corresponding to an area of the assembly unit exhibiting a known defect (e.g., an anomalous feature, cluster of anomalous features); and to further define a nominal dimension of each reference feature and a nominal feature range representing possible values for each dimension of the assembly unit. The computer system can receive a nominal condition for each particular assembly type associated with the facility and store these nominal conditions in a nominal condition database.

Additionally or alternatively, the computer system can: render a set of inspection images, captured by the optical inspection station during production of the assembly unit, within the application executing on the operator's device; prompt the operator to manually define a target region (e.g., a bounding box) for each feature relevant to the operator; receive the set of inspection images annotated with bounding boxes; detect a dominant feature in each bounding box of each inspection image; extract a dimension of each dominant feature from each inspection image; define a range of acceptable values for each dimension; and aggregate these dominant features and ranges of acceptable values into a nominal condition for this assembly type; and store this nominal condition in the nominal condition database.

### 5.2 Autonomous Nominal Condition: Common Feature Modeling

Generally, when a nominal condition defined by the operator is absent, the computer system can autonomously generate a nominal condition for each assembly type within the facility over a particular duration of time (e.g., one day, one week, one month) and store these nominal conditions in the nominal condition database.

More specifically, the computer system can access a set of inspection images of an assembly unit captured by the optical inspection station during production of the assembly unit and implement machine vision techniques to automatically detect physical features (e.g., parts, components, corners, edges, surfaces, surface profiles, geometries, relative positions, relative orientations) exhibited by the assembly unit in each inspection image.

In one implementation, the computer system can: access a sequence of inspection images captured by the optical inspection station, the set of images depicting a set of assembly units, at a particular assembly stage, identified as functional. Then, for each image in the set of images, the computer system can: extract a set of visual features from the image; and detecting an initial constellation of features, representing physical features exhibited on the set of assembly units, based on the set of visual features; extract a dimension of each feature, in the initial constellation of features, from the image; compile constellations of features and corresponding dimensions into a nominal feature range representing functional assembly units; and transmit the nominal feature range to the optical inspection station.

In one variation, the computer system can: access a sequence of inspection images depicting an assembly unit and captured by the optical inspection station during production of the assembly unit; track constellations (or “groups”) of common features between consecutive inspection images in the sequence of inspection images over a period of time (e.g., one hour, one day, one production cycle, five production cycles); and derive and learn models for groups of common features for each assembly type.

For example, the computer system can: access a first sequence of inspection images depicting an assembly unit and captured by the optical inspection station during a first production cycle of the assembly unit; extract timestamps and serial identifiers from the first sequence of images to identify the particular assembly type and the assembly line associated with this assembly unit; detect a group of features exhibited by the assembly unit in a first image in the first sequence of inspection images; track the frequency of occurrence of this group of features between consecutive images in the sequence of inspection images; define a pattern based on the frequency of occurrence of this group of features detected in sequences of inspection images captured by the optical inspection station during future production cycles; define the group of common features as a set of reference features for this particular assembly type; and derive a common feature detection model based on the pattern of the group of features.

Therefore, by tracking constellations of features exhibited on an assembly unit, the computer system can define nominal feature ranges corresponding to functional assembly units. Additionally, by tracking constellations of features exhibited on an assembly unit, the computer system can derive and learn common feature detection models for each assembly type and transmit these models to corresponding optical inspection stations deployed in the facility.

### 5.3 Nominal Dimension

In one variation, the computer system can implement machine vision or other computer vision techniques to extract a dimension (e.g., a size, an area, a length, a width, a height) of each feature in a group of common features, track the dimension of each feature over a period of time (e.g., five production cycles, one day, one week), and define a nominal dimension for each feature. The computer system can then: derive a nominal feature range representing acceptable values for the nominal dimension of each feature; and aggregate the set of reference features, the nominal dimension, and nominal feature range representing acceptable values of each dimension into a nominal condition for this assembly type and store the nominal condition in the nominal condition database.

For example, for each feature in the group of common features, the computer system can: detect the feature exhibited by the assembly unit in the first inspection image in the first sequence of inspection images; detect a quantity of pixels in the first inspection image depicting the feature; derive a geometrical size of the feature based on the quantity of pixels; track the geometrical size of the feature detected in sequences of images captured by the optical inspection station during future production cycles; calculate an average geometrical size of the feature based on geometrical sizes detected in these sequences of images; and define this average geometrical size as a nominal size for the feature.

The computer system can then repeat these methods and techniques, for each other feature and for each other assembly type, to aggregate these reference features and nominal sizes of each reference feature into a nominal feature range and/or a nominal condition and store these nominal conditions in the nominal condition database.

### 5.4 Nominal Feature Ranges Representing Acceptable Values

Additionally, the computer system can generate a prompt for an operator to define a nominal feature range representing acceptable values for each dimension of each common feature and transmit this prompt to the operator via the operator portal or through the display of the optical inspection station.

In one implementation, the computer system receives a nominal feature range of possible or “best-guess” values for each known reference feature of an assembly unit, of a particular assembly type, defined by an engineer via the operator portal; and compiles these nominal feature ranges into a nominal condition for the particular assembly type. For example, the computer system can receive a nominal feature range representing possible values for a known feature, such as a resistor with a nominal feature range representing length values between 6 millimeters and 6.5 millimeters of the assembly unit defined by an engineer via the operator portal. The computer system can then receive a set of (e.g., two) nominal feature ranges representing values for a next known feature of the assembly unit-such as a battery with a first nominal feature range representing width values between 47.5 millimeters and 48.5 millimeters and a second nominal feature range representing height values between 3.25 millimeters and 3.40 millimeters-defined by the engineer via the operator portal. The computer system: compiles these nominal feature ranges for the resistor and the battery into a nominal condition for this particular assembly type; and stores the nominal condition in the nominal condition database.

In another implementation, the computer system: receives a prescribed tolerance-such as +/−5% of the nominal dimension, +/−10% of the nominal dimension, or +/−20% of the nominal dimension—for each known feature of the assembly unit from the operator via the operator portal; defines the nominal feature range representing acceptable values for the nominal dimension of each common feature according to the prescribed tolerance; and compiles these nominal feature ranges representing acceptable values into a nominal condition for this particular assembly type.

The computer system can repeat these methods and techniques for each other assembly type and for each other assembly unit: to autonomously generate a nominal condition for each assembly type in the facility; and to compile these nominal conditions into the nominal condition database. Further, the computer system can retrieve a nominal condition from the nominal condition database prior to detecting features deviating from a corresponding nominal condition for each assembly unit of each assembly type.

### 5.4.1 Historical Data+Nominal Feature Range

In one variation, when a nominal condition defined by the operator is absent, the computer system can automatically apply a preset tolerance to define a nominal feature range representing values for the nominal size of each reference feature. In one example, the computer system automatically applies+/−10% to the nominal size of a reference feature, such as a length of 10 millimeters, to define a tolerance size range of acceptable values, such as between 9 millimeters and 11 millimeters, for the reference feature and aggregates this tolerance size range into the nominal condition.

In another variation, when a nominal condition defined by the operator is absent, the computer system can: access a database of historical values, defined in the past for other types of assembly units or facilities, for a nominal size of each reference feature. For example, the computer system can receive an inspection image, of a single assembly unit, from an optical inspection station; detect a first feature, in a set of features, such as a resistor, in the inspection image based on visual features extracted from the image; access the database of historical values; scan the database for a historical feature corresponding to the first feature, such as a resistor; and, in response to detecting a historical feature analogous to the first feature, define a nominal feature range for the first feature based on historical values associated with the historical feature. The computer system can repeat these methods and techniques for each other feature to automatically define nominal feature ranges and compile these nominal feature ranges representing acceptable values into a nominal condition for this particular assembly type.

In yet another variation, as described in U.S. patent application Ser. No. 16/506,905, filed on 9 Jul. 2019, when a nominal condition defined by the operator is absent, the computer system can: access a database of historical data, defined in the past for other types of assembly units or facilities, for a nominal feature range representing values for a non-physical or non-visual dimension (e.g., a tool setting, an adhesive type, an adhesive application condition, a component batch identifier, timestamped ambient data, or a station operator identifier) of each reference feature.

### 6. AUTONOMOUS CONDITION+ACTION: NEXT ASSEMBLY UNITS

Blocks of the method S100 recite, during a first assembly period: accessing a first image captured at an optical inspection station and depicting a first unverified assembly unit at the particular assembly stage in Block S120; detecting a first constellation of features, in the first image, representing physical features exhibited by the first unverified assembly unit in Block S125; and characterizing differences between dimensions of features in the first constellation of features and corresponding dimensions of features in the initial constellation of features exhibited in the initial verified assembly unit in Block S130.

Generally, the computer system can: access a nominal condition of a particular assembly type within the facility defining a common set of features, a dimension of each feature, and a nominal feature range representing values for each dimension of each feature; receive a sequence of inspection images, of many assembly units, from the set of optical inspection stations associated with this assembly line corresponding to the particular assembly type; and implement machine learning, machine vision, or other computer vision techniques to derive anomalous feature detection models based on patterns of features, detected in this sequence of inspection images, deviating from common features and/or deviating from nominal feature ranges representing acceptable values defined in a corresponding nominal condition.

In one implementation, the computer system can detect a feature as anomalous in response to detecting a dimension value, of the feature, deviating from a nominal feature range representing values of a corresponding reference feature defined in the nominal condition. Further, the computer system can detect a feature as anomalous in response to detecting absence of correspondence between the feature and the set of reference features defined in the nominal condition.

In one variation, in response to detecting absence of correspondence between a feature and a set of reference features defined in a nominal condition, the computer system can: detect the feature as anomalous; identify the feature as a visual defect (e.g., a scratch on a surface of the assembly unit, foreign objects integrated into the assembly unit, debris on a surface of the assembly unit); and highlight a region, depicting the visual defect, within the inspection image.

In another variation, in response to detecting a dimension value of a feature deviating from a nominal feature range representing values of a corresponding reference feature defined in the nominal condition, the computer system can: detect the feature as anomalous; identify the feature as an adhesive defect (e.g., a quantity of glue dispensed onto the assembly unit, absence of an adhesive, foreign objects integrated into the assembly unit, a shape difference); and highlight a region, depicting the adhesive defect, within the inspection image.

Then, in response to detecting an anomalous feature deviating from the nominal condition, the computer system can: rank these anomalous features, such as by dimension (e.g., size) of each feature; annotate (or “highlight”) corresponding regions of the image depicting the highest-ranking anomalous features; generate a prompt for the operator to review these anomalous features and provide an action (e.g., feedback) of each anomalous feature; and serve this highlighted image and the prompt within the application executing on the operator's device or through the display of the optical inspection station, thereby enabling the operator to timely review and focus inspection of the highest-ranking anomalous features representing defective features of the assembly unit rather than all possible anomalous features of the assembly unit.

Further, the operator can provide feedback regarding presence of the anomalous feature in the inspection image based on visual inspection of the annotated inspection image. Responsive to positive feedback of the highest-ranking anomalous features, the computer system can reinforce the anomalous feature detection model identifying the anomalous features of the assembly unit. Additionally or alternatively, responsive to negative feedback indicating the anomalous feature is not anomalous or is benign or normal, the computer system can: expand the nominal feature range representing values of the size for this feature; update the nominal feature range representing values in the corresponding nominal condition within the nominal condition database; and mute notifications for similar future anomalous features of similar assembly units detected along the assembly line.

### 6.1 Anomalous Feature Detection: Absence of Reference Features

In one implementation, the computer system can detect a feature as anomalous in response to detecting absence of correspondence to a reference feature defined in the nominal condition.

For example, the computer system can receive a set of inspection images of many assembly units (e.g., ten, twenty, fifty), of a particular assembly type, recorded by the optical inspection station during production of the assembly units. During a first stage of production of an assembly unit, along an assembly line, the computer system can: access a first inspection image of an assembly unit, in the sequence of inspection images, recorded by the optical inspection station during a first production stage of the assembly unit; retrieve a nominal condition from the nominal condition database associated with the particular assembly type of this assembly unit; detect a first set of features, exhibited by the assembly unit, in the first inspection image; identify correspondence between the first set of features and the set of reference features according to the nominal condition; and, in response to identifying between the first set of features and the set of reference features according to the nominal condition, identify the first set of features as not anomalous (or “normal”).

During a second stage of the production of the assembly unit along the assembly line, the computer system can: access a second inspection image of the assembly unit, in the sequence of inspection images, recorded by the optical inspection station during the second stage of production of the assembly unit; detect a second set of features, exhibited by the assembly unit, in the second inspection image; and, in response to detecting presence of a new subset of features, in the second set of features, different from the set of reference features defined in the nominal condition, identify the new subset of features as anomalous.

Alternatively, in response to detecting absence of a reference feature in the second inspection image, the computer system can: extract a first region from the first inspection image depicting this reference feature; identify a second region corresponding to the first region in the second inspection image; highlight the second region in the second inspection image as anomalous; and present the second inspection image, highlighted with the anomalous feature, to the operator.

Thus, by detecting presence of new features and absence of reference features in an inspection image of an assembly unit, the computer system can detect features exhibited by the assembly unit as anomalous.

6.2 Anomalous Feature Detection: Deviation from Nominal Location

In one variation, the computer system can implement thresholds for detecting anomalous features of assembly units and refine these thresholds over time based on feedback from the operator. Further, the computer system can detect anomalous features of assembly units for each assembly type that exhibit a relative location deviating from nominal locations of corresponding nominal features as defined in corresponding nominal conditions.

In one implementation, the computer system implements methods and techniques described above to access a new inspection image for a new assembly unit recorded by the optical inspection station during production of the new assembly unit and detect a feature occupying a relative location in the new inspection image. The computer system can then: retrieve a corresponding nominal feature and corresponding nominal location from a nominal condition associated with the assembly type of this new assembly unit; detect an offset distance between the relative location and the nominal location; and, in response to the feature deviating from the nominal feature by more than a low preset threshold distance, identify the feature as anomalous.

Alternatively, in response to the feature deviating from the nominal feature by more than a high preset threshold distance, the computer system can: identify the feature as anomalous in the relative location within the inspection image; highlight the anomalous feature in the inspection image; generate a prompt for feedback of the anomalous feature; and present the prompt and the region-of-interest within the image that depicts the anomalous feature to the operator-such as through the optical inspection station or the application executing on the operator's device—for review of the anomalous feature.

### 6.3 Rank Anomalous Features

Further, the computer system can: rank each anomalous feature of an assembly unit in descending numerical order according to the magnitude of deviation from the common features and/or tolerance value ranges; select a highest-ranking set of anomalous features to highlight within the image depicting the assembly unit; and serve this highest-ranking set of anomalous features to the operator within the application executing on the operator's device.

In one implementation, for each anomalous feature, the computer system can: implement methods and techniques described above to detect a set of anomalous features of a new assembly unit; detect a difference between the size of a first anomalous feature and the nominal size of a corresponding reference feature, defined in the nominal condition; calculate an anomaly score for the anomalous feature based on the difference; and rank each anomalous feature of the assembly unit by anomaly score in numerical order.

For example, the computer system can: detect a first anomalous feature of a new assembly unit of a particular assembly type; extract a size of the first anomalous feature, such as 50 millimeters in the X-direction, 25 millimeters in the Y-direction, and 30 millimeters in the Z-direction, from the inspection image of the new assembly unit; access the nominal size of the corresponding reference feature, such as 40 millimeters in the X-direction, 25 millimeters in the Y-direction, and 20 millimeters in the Z-direction, defined in the nominal condition associated with this particular assembly type; implement statistical techniques to detect a percentage difference, such as 20.6% difference in size by calculating an average of 22% difference in the X-direction, 0% in the Y-direction difference, and 40% difference in the Z-direction, between the size of the first anomalous feature and the nominal size of the corresponding reference feature in each direction; and, in response to the percentage difference falling within a predefined range of values assigned to an anomaly score, such as seven, assign the anomaly score of seven to this first anomalous feature of the new assembly unit.

Further, the computer system can: detect a second anomalous feature of the new assembly unit; extract a size of the second anomalous feature, such as 49 millimeters in the X-direction, 25 millimeters in the Y-direction, and 38 millimeters in the Z-direction, from the inspection image of the new assembly unit; access the nominal size of the corresponding reference feature, such as 45 millimeters in the X-direction, 25 millimeters in the Y-direction, and 40 millimeters in the Z-direction, defined in the nominal condition associated with this particular assembly type; implement statistical techniques to detect a percentage difference, such as 4.55% difference in size by calculating an average of 8.51% difference in the X-direction, 0% in the Y-direction difference, and 5.13% difference in the Z-direction, between the size of the second anomalous feature and the nominal size of the corresponding reference feature in each direction; and, in response to the percentage difference falling within a predefined range of values assigned to an anomaly score (e.g., two), assign the anomaly score (e.g., two) to the second anomalous feature of the new assembly unit. The computer system can then rank the anomalous features of the new assembly unit according to the anomaly score and present the anomalous features with an anomaly score greater than a threshold anomaly score (e.g., six) to the operator via the application executing on the operator's device, as further described below.

Therefore, by ranking the set of anomalous features, the computer system can enable the operator to timely review and focus inspection of the highest-ranking anomalous features representing defective parts or components of the assembly unit in real-time during each stage of production rather than review all possible anomalous features of the assembly unit post-production of the assembly unit.

### 6.3.1 Feature List

In one implementation, the computer system can: define a feature list representing shared physical characteristics across the assembly units (i.e., the initial assembly unit, the primary assembly unit), such as dimensions, geometries, relative positions, orientations, and surface profiles derived from an initial constellation of features detected in a verified assembly unit; rank shared features in the feature list according to the magnitude of differences, such as spatial offsets, dimension variances, or angular deviations, across corresponding constellations of features between the initial verified assembly unit and a primary unverified assembly unit; and select a set of features, such as the highest-ranked features exceeding a predefined deviation threshold, for presentation to an operator interfacing with an operator portal, such as through an annotated image rendered on a mobile device or workstation associated with the operator.

In this implementation, the computer system can: calculate differences between corresponding features in the initial constellation of features and the first constellation of features, such as by measuring deviations in spatial coordinates, dimensional variances, or angular offsets between matched features in the two constellations; and define the feature list (e.g., a list ranking features such as edges, surfaces, or specific components like fasteners or connectors) that ranks differences between the corresponding features based on the magnitude of difference.

For example, the computer system can calculate differences between: shapes of corresponding features, such as deviations in curvature profiles of an assembly edge or inconsistencies in radii of circular components; areas of corresponding features, such as differences in the surface area of planar components (e.g., a rectangular bracket or a flat mounting plate); and distances between corresponding features, such as offsets between connection points (e.g., the distance between screw holes on a bracket and their expected locations). The computer system can then: select a set of features in the feature list that exhibit the greatest magnitude of difference, such as the three top-ranked features in the list, including significant deviations in bolt alignments, connector positions, or surface flatness; and, as described above, render images depicting these assembly units at the operator portal for manual inspection by the operator, highlighting the selected features with visual markers (e.g., colored bounding boxes or annotations).

Therefore, the computer system can present relative features of interest to the operator in order to facilitate targeted manual inspection of potential defects, such as deviations in component alignment, surface irregularities, or missing elements, and enable the operator to confirm or reject these flagged features of interest as anomalies.

### 6.4 Serve Anomalous Features to Operator

Generally, the computer system can: interface with a display of the optical inspection station to present the highest-ranking set of anomalous features to the operator.

In one implementation, the computer system can: identify a highest-ranking subset of anomalous features (e.g., an anomalous feature with an anomaly score greater than seven, an anomalous feature with an anomaly score greater than nine), in the set of anomalous features, representing defective parts or components of the assembly unit; annotate (e.g., highlight, flag) regions of the inspection image depicting the highest-ranking subset of anomalous features of the assembly unit; and render this annotated inspection image within the display of the optical inspection station for the operator to review.

For example, responsive to identifying a highest-ranking anomalous feature with an anomaly score of ten, in the set of anomalous features, the computer system can; annotate a region of the inspection image depicting the highest-ranking anomalous feature of the assembly unit of a particular type-such as by overlaying a red colored marker or red colored bounding box over the region of the inspection image, depicting the highest-ranking anomalous feature; identify a first subset of high-ranking anomalous features, in the set of anomalous features, with anomaly scores of eight and nine; overlay a yellow colored marker or yellow bounding box over corresponding regions of the inspection image depicting the subset of high-ranking anomalous features; and present the inspection image to an operator of the assembly line within the display of the optical inspection station for the operator to review.

In one variation, the computer system can: access a predefined target quantity of anomalous features from the operator (e.g., ten anomalous features, five anomalous features, three anomalous features); identify a highest-ranking subset of anomalous features, in the set of anomalous features, according to the predefined target quantity of anomalous features; highlight each corresponding region of the inspection image depicting an anomalous feature of the assembly unit with a colored bounding box; and present the highlighted inspection image to the operator through the display of the optical inspection station associated with the inspection image.

In another variation, the computer system can devalue or mute anomalous features exhibiting an anomaly score less than a predefined threshold score and/or characterized by a quantity exceeding a threshold quantity of anomalous features. Conversely, the computer system can emphasize anomalous features exhibiting an anomaly score exceeding the predefined threshold score and/or characterized by a quantity falling below the threshold quantity of anomalous features. The computer system can then implement methods and techniques described above to present weighted anomalous features to the operator through the display of the optical inspection station and, thereby, reduce compute load and time, increase processing speed, and increase the accuracy of detection of anomalous features that represent defective parts or components of the assembly unit.

Alternatively, the computer system can implement the methods and techniques described above to render an annotated inspection image within an operator portal or to present weighted anomalous features within an operator portal for asynchronous review by a secondary operator (e.g., an engineer associated with the assembly unit).

### 7. MANUAL OPERATOR FEEDBACK+TUNING NOMINAL FEATURE RANGES

Blocks of the method S100 recite, during the first assembly period: identifying a first dimension of a first feature of interest, in the first constellation of features, distinct from a first verified dimension of the first feature of interest in the initial constellation of features in Block S140; and rendering a first visual representation of the first unverified assembly unit on a display at the optical inspection station, the first visual representation indicating the first feature of interest on the first unverified assembly unit in Block S150. Blocks of the method S100 further recite, during the first assembly period and in response to receiving manual verification of the first feature of interest on the first unverified assembly unit at the optical inspection station, defining a first verified feature range of the first feature of interest in Block S160. The first verified feature range is bounded by the first dimension of the first feature of interest and the first verified dimension of the first feature of interest extracted from the initial image.

Generally, the operator can provide feedback regarding presence of each anomalous feature highlighted in the inspection image based on visual inspection of the inspection image. Further, responsive to feedback of an anomalous feature, the computer system can automatically reinforce the anomalous feature detection model and/or adjust the nominal feature range representing values of the dimension of the anomalous feature.

In one implementation, responsive to positive feedback from an operator at the optical inspection station, indicating the anomalous feature as anomalous and corresponding to a defective part or component of the assembly unit, the computer system can reinforce the anomalous feature detection model and continue to present similar anomalous features exhibited by similar assembly units of this particular assembly type in the future.

Additionally or alternatively, responsive to negative feedback of an anomalous feature indicating the anomalous feature is benign or that the anomalous feature is acceptable or normal, the computer system can: expand the nominal feature range representing values of the dimension for this anomalous feature; update the nominal feature range in the corresponding nominal condition within the nominal condition database; retrain the anomalous feature detection model based on the updated nominal feature range; and mute notifications for similar anomalous features exhibited by similar assembly units of this particular assembly type in the future.

### 7.1 Distinct Dimensions

In one implementation, the computer system can identify a dimension of a feature of interest, in a constellation of features, as distinct from a verified dimension by: identifying the dimension within the verified bounds of a nominal feature range containing the verified dimension; and detecting the dimension as offset from a cluster of dimensions, in the nominal feature range, previously verified at the optical inspection station. For example, the computer system can identify a hole alignment dimension of a feature of interest, in a constellation of features detected from an image of an assembly unit, as distinct from a verified alignment dimension by: identifying the hole alignment dimension within the verified bounds of a nominal feature range, such as ±0.5 millimeters; and detecting the hole alignment dimension as offset by 0.3 millimeters from a cluster of dimensions previously verified at the optical inspection station, such as a cluster centered at 0.0 millimeters with a tolerance of ±0.1 millimeters.

In another implementation, the computer system can identify a dimension of a feature of interest, in a constellation of features, as distinct from a verified dimension by: identifying the dimension within the verified bounds of a nominal feature range containing the verified dimension, such as alignment tolerances of ±0.5 millimeters for a hole placement; and detecting the dimension as offset from a cluster of dimensions, in the nominal feature range, previously verified at the optical inspection station, such as by determining an offset of 0.3 millimeters from a cluster centered at 0.0 millimeters with a tolerance of ±0.1 millimeters.

Therefore, the computer system can verify anomalous features by analyzing detected dimensions against nominal feature ranges and clusters of previously verified dimensions for both verified and unverified assembly units to identify deviations that indicate potential defects at specific assembly stages.

### 7.2 Rendering Visual Representation

In one implementation, the computer system can: generate a prompt requesting an operator to manually review differences of corresponding features between the initial assembly unit and the primary assembly unit; render images of assembly units (i.e., the initial assembly unit and the primary assembly unit) at an operator portal (e.g., at the optical inspection station); and annotate these rendered images with feature dimensions, such as lengths, widths, angles, or spatial offsets, to highlight deviations between corresponding features; and serve the prompt at the operator portal.

In this implementation, the computer system can: render the initial image depicting the verified assembly unit at the operator portal; identify a target region, in the initial image, containing a primary feature of interest, such as a critical joint, connector, or edge alignment; and annotate the target region in the initial image with an initial dimension (e.g., a length of 10 millimeters or an angle of) 90° of the primary feature of interest. Additionally, the computer system can: render the primary image depicting the unverified assembly unit—adjacent to the initial image—at the operator portal; identify the target region, in the primary image, containing the primary feature of interest, such as the same joint, connector, or edge alignment; and annotate the target region in the primary image with a primary dimension (e.g., a length of 9.5 millimeters or an angle of 87°) of the primary feature of interest.

For example, the computer system can juxtapose two features by analyzing the alignment and size of corresponding screw holes in the initial assembly unit and the unverified assembly unit. In this example, the computer system can calculate the deviation in hole diameter (e.g., five millimeters in the initial unit versus four point eight millimeters in the unverified unit) and the offset in the hole center positions (e.g., 0.3 millimeters displacement along the X-axis). The computer system can annotate these differences on rendered images displayed at the operator portal for manual verification.

The computer system can then: at the operator portal, receive verification of the annotated feature dimensions and positional alignment from an operator representing functionality of the first unverified assembly unit; and identify the unverified assembly unit as a verified assembly unit upon receiving confirmation that the feature dimensions and alignment fall within acceptable tolerances.

Therefore, the computer system can receive manual operator feedback in order to tune nominal feature ranges across shared constellations of features between verified assembly units and unverified assembly units, thereby dynamically refining dimensional and positional tolerances for consistent quality control.

### 7.3 Reference Comparison

In one implementation, during an assembly period, the computer system can sequentially characterize differences (e.g., dimensional differences) between constellations of features of an unverified assembly unit at the optical inspection station and a verified assembly unit previously verified during the assembly period. In this implementation, during the assembly period, the computer system can: characterize differences between dimensions of constellations of features associated with an unverified assembly unit and dimensions of constellations of features associated with a verified assembly unit (e.g., previously verified during the assembly period); and identify a dimension of a feature of interest-exclusive of dimensions of features of interest previously identified during the assembly period-exhibiting a difference (e.g., exceeding a threshold difference) between the dimensions of the constellations of features.

For example, during the assembly period, the computer system can: identify a verified assembly unit as a reference unit after confirming all features fall within acceptable tolerances; and store the primary constellation of features for the verified assembly unit as the baseline for subsequent comparisons. When an unverified assembly unit arrives at the optical inspection station, the computer system can: compare the primary constellation of features of the unverified assembly unit (e.g., alignment of screw holes, dimensions of mounting brackets, curvature of surface edges) against the reference unit (i.e., the verified assembly unit); detect deviations—such as a screw hole offset by 0.5 millimeters and/or deviation of a surface curvature radius by one millimeter—between the unverified assembly unit and the verified assembly unit; and flag the features exhibiting deviations as anomalies. The computer system can then: generate a prompt for the operator for manual inspection of the unverified assembly unit; and serve the prompt to the operator portal.

Accordingly, in response to receiving the rejection of the feature of interest, the computer system can: identify the unverified assembly unit as a non-functional assembly unit; generate a prompt requesting an operator to reassemble the unverified assembly unit prior to removal of the unverified assembly unit from the optical inspection station; and serve the prompt to an operator portal.

Therefore, the computer system can implement a rolling reference comparison by continuously updating the baseline of verified assembly units during the assembly period. Thus, dynamically comparing unverified assembly units against the most recently verified units to account for evolving production tolerances or variations in real time.

### 7.3.1 Operator Portal: Excluding Verified Features

In one implementation, in response to identifying a dimension of a feature of interest as distinct from a previously verified dimension and in response to another dimension of a different feature of interest falling within the verified feature range, the computer system can: render a visual representation-highlighting (e.g., using color overlays or bounding boxes) the distinct feature of interest on the unverified assembly unit and excluding (e.g., omitting annotations or visual markers) indication of the feature of interest that falls within the verified range-on the display at the optical inspection station; and render a prompt to verify the distinct feature of interest depicted in the second visual representation of the unverified assembly unit. Accordingly, in response to receiving manual verification of the feature of interest on the unverified assembly unit at the optical inspection station, the computer system can define the verified feature range—containing the dimension of the feature of interest extracted from the corresponding image—of the feature of interest.

For example, the computer system can: render a visual representation on the display at the optical inspection station, highlighting a misaligned component on an unverified assembly unit with a bounding box and excluding visual markers for components that are already within verified alignment tolerances; render a prompt requesting manual verification of the misaligned component; and, in response to receiving manual verification, define the verified feature range for the component, containing the newly verified alignment dimension extracted from the corresponding image.

Therefore, the computer system can present only relevant and important features to the operator by excluding verified features from visual representations, reducing cognitive load and focusing manual verification of unverified or anomalous features on the unverified assembly unit.

7.4 Feature Range Tuning

In one implementation, during a primary assembly period, the computer system can: characterize differences between dimensions in the primary constellation of features, representing verified assembly units, and dimensions in the secondary constellation of features, associated with unverified assembly units inspected during the same assembly period; and identify a dimension of a feature of interest-exclusive of dimensions of previously identified features-such as a newly detected dimensional variance or positional deviation, and exhibiting a difference exceeding a predefined threshold between the primary and secondary constellations of features. The computer system can then: receive manual verification of the dimension for the feature of interest, in the secondary constellation of features, offset from a corresponding dimension defined in the primary constellation of features; and define a nominal feature range for verifying the feature of interest bounded by the verified dimension from the secondary constellation and the corresponding dimension from the primary constellation of features.

The computer system can then, during a secondary assembly period following the primary assembly period: access an image captured for the next unverified assembly unit at the optical inspection station; detect a constellation of features in the image, including dimensions, surface geometries, and positional alignments; identify a dimension of a primary feature of interest in the constellation of features as falling within a nominal feature range defined for verified assembly units of the same type; and identify a dimension of a secondary feature of interest in the constellation of features as falling outside the nominal feature range defined for acceptable tolerances, indicating a potential defect. Accordingly, the computer system can: identify the unverified assembly unit as a non-functional assembly unit, based on the secondary feature of interest exceeding the acceptable nominal feature range; and prompt an operator to manually review the unverified assembly unit prior to proceeding in the assembly line.

Therefore, the computer system can iteratively refine the evaluation of unverified assembly units by comparing their constellations of features to nominal feature ranges derived from verified units during the assembly period. Accordingly, the computer system can: identify non-functional units in real time to minimize the propagation of defects through subsequent assembly stages; and maintain consistent assembly quality throughout the production process.

### 7.5 Environmental Conditions

In one implementation, the computer system can: track a sequence of ambient temperature values during an initial assembly period from a temperature sensor arranged proximal to the optical inspection station; monitor a subsequent sequence of ambient temperature values during a later assembly period from the temperature sensor, recording variations in environmental conditions (e.g., shifts in temperature, humidity, or air pressure); and, in response to the subsequent sequence of ambient temperature values exceeding a predefined threshold temperature value (e.g., 30 degrees Celsius), constrain the nominal feature range, such as by narrowing acceptable tolerances for feature dimensions and alignments to account for potential thermal expansion or contraction effects on the assembly units. For example, the computer system can narrow acceptable tolerances for feature dimensions (e.g., reducing alignment tolerance from ±0.5 millimeters to ±0.3 millimeters) and angular tolerances (e.g., tightening from ±1 degree to ±0.7 degrees) to account for potential thermal expansion or contraction effects on the assembly units.

In another example, during a primary assembly period, the computer system can: track a sequence of ambient temperature values, such as between 20 and 25 degrees Celsius; and define nominal feature ranges for features of interest. During a secondary assembly period, the computer system can: detect an ambient temperature exceeding a predefined threshold (e.g., 30 degrees Celsius due to seasonal heat); and, in response to detecting the ambient temperature exceeding the predefined threshold, constrain the nominal feature range proportional to the increase in ambient temperature proximal the optical inspection station, such as by reducing alignment tolerance of a particular feature of interest to ±0.3 millimeters and angular tolerance to ±0.7 degrees to compensate for combined thermal and moisture effects on material dimensions.

Therefore, the computer system can dynamically modify nominal feature ranges in response to variations in environmental conditions (e.g., temperature fluctuations above 30 degrees Celsius, high humidity exceeding 80%) to maintain consistent defect detection accuracy under diverse production environments.

### 7.6 Assembly Unit Variations

In one implementation, the computer system can: identify variations in assembly units by analyzing product-specific attributes, such as differences in component sizes between distinct stock-keeping units (SKUs) (e.g., large versus small variants) and variations in visual properties (e.g., color differences between product lines); and modify (e.g., expand, constrain) nominal feature ranges for corresponding features of interest based on these variations, such as by adjusting dimensional tolerances to accommodate size differences across SKUs, refining feature thresholds to account for color variations that do not impact functional performance, and dynamically learning correlations between multivariate feature data and downstream failures to further refine feature range definitions over successive assembly periods.

In one example, the computer system can: identify a hole placement dimension of 10 millimeters as anomalous for a small assembly unit (e.g., a standard-sized smartphone, compact wearable device), where the nominal feature range for the small assembly unit is defined as 7 to 9 millimeters; identify the same 10-millimeter hole placement dimension as within the nominal feature range for a large assembly unit (e.g., a plus-sized smartphone, tablet device), where the nominal feature range is defined as 9 to 12 millimeters; and modify the nominal feature ranges by constraining the feature range for the small assembly unit and expanding the feature range for the large assembly unit to maintain accurate defect classification based on assembly unit size variations.

Therefore, the computer system can refine nominal feature ranges across different variations of assembly units by: analyzing dimensional differences specific to each variation; incorporating product-specific attributes, such as size and visual properties; and dynamically adjusting feature thresholds to maintain consistent defect detection across diverse assembly unit configurations.

### 8. IMPLICIT VERIFICATION

Blocks of the method S100 recite: accessing a second image, captured at the optical inspection station, depicting a second unverified assembly unit at the particular assembly stage in Block S120; detecting a second constellation of features, in the second image, representing physical features exhibited by the second unverified assembly unit in Block S125; and, in response to the first feature of interest in the second constellation of features falling within the first nominal feature range, identifying the first feature of interest in the second constellation of features as a verified feature of interest in Block S170.

Generally, the computer system can access images of unverified assembly units captured at the optical inspection station; detect constellations of features representing physical characteristics, including dimensions, of the unverified assembly units; evaluate the detected dimensions against nominal feature ranges derived from verified assembly units; and identify dimensions falling within the nominal ranges as verified, thus reducing reliance on manual intervention and ensuring consistent quality control during the assembly process.

### 8.1 Feature Range Clustering

In one implementation, the computer system can: identify a set of images, captured during a subsequent assembly period, as depicting assembly units with dimensions within constellations of features falling within the nominal feature range; group neighboring dimensions, detected within constellations of features in the images, into a cluster occupying a first region of the nominal feature range, such as based on proximity of dimensions to the nominal feature range and shared feature characteristics (e.g., geometric patterns, positional alignments); identify a dimension within a constellation of features, detected in an image associated with a verified assembly unit, as occupying a second region outside the first region of the nominal feature range; and flag the image associated with the verified assembly unit for manual review by an operator. In this implementation, in response to the operator rejecting the flagged assembly unit, the computer system can: constrain the nominal feature range to the first region occupied by the cluster of dimensions in order to dynamically refine future defect detection processes and to to improve precision and accuracy in evaluating unverified assembly units.

In one example, the computer system can: identify a set of images, captured during an assembly period, as depicting assembly units with dimensions within constellations of features falling within a nominal feature range for component alignment, such as tolerances of ±0.5 millimeters for hole placement and ±1 degree for angular alignment; group neighboring dimensions, detected within constellations of features in the images, into a cluster occupying a first region of the nominal feature range, such as alignment deviations within ±0.3 millimeters and ±0.5 degrees; detect a dimension within a constellation of features, in an image associated with a verified assembly unit, as occupying a second region outside the first region in the nominal feature range, such as a hole placement deviating by 0.6 millimeters and angular alignment exceeding 1.5 degrees; and flag the image associated with the verified assembly unit for manual review by the operator.

In this example, in response to receiving rejection of the flagged assembly unit from the operator, the computer system can: constrain the nominal feature range to the first region occupied by the cluster of dimensions; and dynamically refine tolerances for subsequent assembly periods to maintain precision and accuracy of defect detection during these assembly periods.

Therefore, the computer system can extract insights from clusters of dimensions formed over time, identifying patterns, trends, and deviations that inform the refinement of nominal feature ranges and increase accuracy of defect detection across assembly periods.

### 8.2 Inclusion Range

In one implementation, the computer system can: access an image, captured at the optical inspection station, depicting an unverified assembly unit at the particular assembly stage; and detect a constellation of features, in the image, representing physical features exhibited by the unverified assembly unit. The computer system can then, in response to a dimension of a feature of interest in the constellation of features falling outside the nominal feature range and within a threshold deviation from an initial dimension of the first nominal feature range: generate a prompt requesting an operator to manually verify the feature of interest from the constellation of features; and serve the prompt to an operator portal. Additionally, the computer system can: receive verification of the dimension for the feature of interest in the constellation of features; and, in response to receiving verification of the dimension, define an inclusion range for the first nominal feature range, bounded by the initial dimension and the verified dimension.

Accordingly, the computer system can then: detect a cluster of assembly units, identified as non-functional assembly units, with constellations of features falling within the inclusion range of the first nominal feature range; and, in response to detecting the cluster of assembly units falling within the inclusion range, identify the cluster of assembly units as functional assembly units.

For example, the computer system can: detect a constellation of features in an image depicting an unverified assembly unit at the optical inspection station, including a hole alignment approximating 0.6 millimeters, which falls outside the nominal feature range of ±0.5 millimeters but remains within a threshold deviation of 0.1 millimeters; generate a prompt requesting an operator to manually verify the hole alignment; receive operator verification of the hole alignment at 0.6 millimeters; define an inclusion range for the nominal feature range, bounded by the initial dimension (0.5 millimeters) and the verified dimension (0.6 millimeters); and detect a cluster of assembly units with constellations of features approximating the inclusion range and identify these units as functional.

Therefore, the computer system can dynamically refine nominal feature ranges by incorporating operator verification and defining margins of inclusion to: detect deviations approximating acceptable thresholds; and reclassify clusters of assembly units—previously identified as non-functional assembly units—as functional assembly units.

### 8.3 Rejection Range

In one implementation, in response to receiving manual rejection of the feature of interest on the unverified assembly unit at the optical inspection station, the computer system can: define a rejection range for the feature of interest, isolated from the verified feature range and containing the dimension of the feature of interest extracted from the corresponding image; and reject the unverified assembly unit. Accordingly, the computer system can: retrieve dimensions of constellations of features for assembly units that fall within the rejection range; and reject the assembly units with constellations of features falling within the rejection range.

For example, the computer system can: define a rejection range for a misaligned hole placement feature on an unverified assembly unit, isolated from the verified alignment range of ±0.5 millimeters, and containing a dimension of 0.8 millimeters extracted from the corresponding image; retrieve dimensions of hole placement features from constellations of features across assembly units that fall within the rejection range, such as hole alignments deviating beyond ±0.7 millimeters; and reject the assembly units with constellations of features containing hole alignments within this rejection range.

Therefore, the computer system can propagate the rejection range to autonomously reject previously inspected assembly units at the optical inspection station to maintain constant classification of assembly units with dimensions falling within the rejection range.

8.3.1 Insights from Rejected Units

In one implementation, the computer system can: characterize differences between dimensions of features in the constellation of features exhibited by the rejected assembly unit and corresponding dimensions of features in the constellation of features exhibited by the previously inspected assembly unit; and identify a dimension of a feature of interest in the rejected assembly unit's constellation of features as distinct from a verified dimension of the same feature of interest previously verified for the previously inspected assembly unit. In this implementation, the computer system can then: render a visual representation-further highlighting the feature of interest on the rejected assembly unit—of the rejected assembly unit on the display at the optical inspection station; and render a prompt requesting manual verification of the feature of interest depicted in the visual representation of the rejected assembly unit.

Accordingly, in response to receiving manual verification of the feature of interest on the rejected assembly unit at the optical inspection station, the computer system can define a verified feature range-containing the dimension of the feature of interest extracted from the corresponding image of the rejected assembly unit—for the feature of interest.

For example, the computer system can: characterize differences between the surface texture of a metal casing in a rejected assembly unit and the surface texture of the same casing in a previously inspected assembly unit; identify the rejected assembly unit's casing as exhibiting a roughness value of 1.2 micrometers deviating from the verified range of 0.5 to 0.8 micrometers; render a visual representation—highlighting the region of the casing with excessive surface roughness using a color overlay—of the rejected assembly unit; and render a prompt requesting the operator to verify the highlighted surface roughness dimension in the visual representation of the rejected assembly unit. Thus, in response to receiving manual verification, the computer system can define a verified feature range for the surface roughness, bounded by the verified dimensions extracted from the rejected assembly unit's image.

Therefore, the computer system can extract further insights for verifying features of interest by analyzing dimensions and characteristics of rejected assembly units to refine verification criteria of feature ranges.

### 9. CONCLUSION

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing an initial image depicting a verified assembly unit at a particular assembly stage;
detecting an initial constellation of features, in the initial image, representing physical features exhibited by the verified assembly unit;
during a first assembly period:
accessing a first image captured at an optical inspection station and depicting a first unverified assembly unit at the particular assembly stage;
detecting a first constellation of features, in the first image, representing physical features exhibited by the first unverified assembly unit;
characterizing differences between dimensions of features in the first constellation of features and corresponding dimensions of features in the initial constellation of features exhibited in the initial verified assembly unit;
identifying a first dimension of a first feature of interest, in the first constellation of features, distinct from a first verified dimension of the first feature of interest in the initial constellation of features;
rendering a first visual representation of the first unverified assembly unit on a display at the optical inspection station, the first visual representation indicating the first feature of interest on the first unverified assembly unit;
in response to receiving manual verification of the first feature of interest on the first unverified assembly unit at the optical inspection station:
defining a first verified feature range of the first feature of interest, the first verified feature range bounded by the first dimension of the first feature of interest and the first verified dimension of the first feature of interest extracted from the initial image; and
during a second assembly period following the first assembly period:
accessing a second image captured at the optical inspection station and depicting a second unverified assembly unit at the particular assembly stage;
detecting a second constellation of features, in the second image, representing physical features exhibited by the second unverified assembly unit;
extracting a second dimension of the first feature of interest, in the second constellation of features, from the second image; and
in response to the second dimension of the first feature of interest falling within the first verified feature range, verifying the first feature of interest depicted in the second unverified assembly unit.

2. The method of claim 1, wherein identifying the first dimension of the first feature of interest in the first constellation of features, distinct from the first verified dimension, comprises identifying the first dimension outside of verified bounds from a nominal feature range containing the first verified dimension.

3. The method of claim 1, wherein identifying the first dimension of the first feature of interest in the first constellation of features, distinct from the first verified dimension, comprises identifying the first dimension within verified bounds of a nominal feature range containing the first verified instruction and offset from a cluster of dimensions, in the nominal feature range, previously verified at the optical inspection station.

4. The method of claim 1, further comprising, during the first assembly period:
identifying a second dimension of a second feature of interest in the first constellation of features, distinct from a second verified dimension of the second feature of interest in the initial constellation of features;
rendering the first visual representation of the first unverified assembly unit on the display at the optical inspection station, the first visual representation further indicating the second feature of interest on the first unverified assembly unit;
rendering a first prompt to verify the first feature of interest and the second feature of interest depicted in the first visual representation of the first unverified assembly unit; and
in response to receiving manual verification of the second feature of interest on the first unverified assembly unit at the optical inspection station:
defining a second verified feature range of the second feature of interest, the second verified feature range bounded by the second dimension of the second feature of interest extracted from the first image and the second verified dimension of the second feature of interest extracted from the initial image.

5. The method of claim 4, further comprising, during the second assembly period:
extracting a third dimension of the second feature of interest, in the second constellation of features, from the second image;
in response to the third dimension of the second feature of interest falling outside of the second verified feature range:
rendering a second visual representation of the second unverified assembly unit on the display at the optical inspection station, the second visual representation indicating the second feature of interest on the second unverified assembly unit; and
rendering a second prompt to verify the second feature of interest depicted in the second visual representation of the second unverified assembly unit; and
in response to receiving manual verification of the second feature of interest on the second unverified assembly unit at the optical inspection station:
expanding the second verified feature range of the second feature of interest to contain the third dimension of the second feature of interest extracted from the second image.

6. The method of claim 1, further comprising, during the second assembly period:
identifying a second dimension of a second feature of interest, in the second constellation of features, distinct from a second verified dimension of the second feature of interest in the first constellation of features;
in response to identifying the second dimension of the second feature of interest distinct from the second verified dimension and in response to the first dimension of the first feature of interest falling within the first verified feature range:
rendering a second visual representation on the display at the optical inspection station, the second visual representation indicating the second feature of interest on the second unverified assembly unit and excluding indication of the first feature of interest on the second unverified assembly unit; and
rendering a prompt to verify the second feature of interest depicted in the second visual representation of the second unverified assembly unit; and
in response to receiving manual verification of the second feature of interest on the second unverified assembly unit at the optical inspection station:
defining a second verified feature range of the second feature of interest, the second verified feature range containing a second dimension of the second feature of interest extracted from the second image.

7. The method of claim 1, further comprising, during a third assembly period following the first assembly period:
accessing a third image captured at the optical inspection station and depicting a third unverified assembly unit at the particular assembly stage;
detecting a third constellation of features, in the third image, representing physical features exhibited by the third unverified assembly unit;
extracting a third dimension of the first feature of interest, in the third constellation of features, from the third image;
in response to the third dimension of the first feature of interest falling outside of the first verified feature range:
rendering a third visual representation of the third unverified assembly unit on the display at the optical inspection station, the third visual representation indicating the first feature of interest on the third unverified assembly unit; and
rendering a first prompt to verify the first feature of interest depicted in the third visual representation of the third unverified assembly unit; and
in response to receiving manual rejection of the first feature of interest on the third unverified assembly unit at the optical inspection station:
defining a first rejection range of the first feature of interest isolated from the first verified feature range of the first feature of interest and containing the third dimension of the first feature of interest extracted from the third image; and
rejecting the third unverified assembly unit.

8. The method of claim 7, further comprising, during the third assembly period:
characterizing differences between dimensions of features in the third constellation of features and corresponding dimensions of features in the second constellation of features exhibited by the second unverified assembly unit;
identifying a fourth dimension of a second feature of interest, in the third constellation of features, distinct from a fifth dimension of the second feature of interest previously verified for the second unverified assembly unit;
rendering the third visual representation of the third unverified assembly unit on the display at the optical inspection station, the third visual representation further indicating the second feature of interest on the third unverified assembly unit;
rendering a second prompt to verify the second feature of interest depicted in the third visual representation of the third unverified assembly unit; and
in response to receiving manual verification of the second feature of interest on the third unverified assembly unit at the optical inspection station:
defining a second verified feature range of the second feature of interest, the second verified feature range containing the fourth dimension of the second feature of interest extracted from the third image.

9. The method of claim 1:
further comprising defining a dimension list that ranks differences between dimensions of features in the first constellation of features and corresponding dimensions of features in the initial constellation of features based on magnitude of difference; and
wherein identifying the first dimension of the first feature of interest, in the first constellation of features, distinct from a first verified dimension of the first feature of interest in the initial constellation of features comprises:
in the dimension list, identifying the first dimension of the first feature of interest in the first constellation of features exhibiting a greatest magnitude of difference to the first verified dimension of the first feature of interest in the initial constellation of features.

10. The method of claim 1, wherein characterizing differences between dimensions of features in the first constellation of features and corresponding dimension of features in the initial constellation of features comprises characterizing differences between:
shapes of features in the first constellation of features and corresponding shapes of features in the initial constellation of features;
areas of features in the first constellation of features and corresponding areas of features in the initial constellation of features; and
distances across features in the first constellation of features and corresponding differences across features in the initial constellation of features.

11. The method of claim 1:
further comprising, during the first assembly period:
rendering an initial visual representation of the verified assembly unit on the display at the optical inspection station;
identifying a first region, in the initial visual representation, containing the first feature of interest; and
annotating the first region, in the initial visual representation, with the first verified dimension of the first feature of interest extracted from the initial image;
wherein rendering the first visual representation of the first unverified assembly unit on the display at the optical inspection station comprises:
rendering the first visual representation of the first unverified assembly unit adjacent the initial visual representation on the display at the optical inspection station;
identifying a second region, in the first visual representation, containing the first feature of interest; and
annotating the second region, in the first visual representation, with the first dimension of the first feature of interest extracted from the first image; and
wherein receiving manual verification of the first feature of interest on the first unverified assembly unit at the optical inspection station comprises:
at an operator portal at the optical inspection station, receiving manual verification of the first feature of interest from an operator associated with the optical inspection station.

12. The method of claim 1, further comprising:
during the first assembly period, tracking a first sequence of ambient temperature values from a temperature sensor arranged proximal the optical inspection station; and
during the second assembly period:
tracking a second sequence of ambient temperature values from the temperature sensor; and
in response to the second sequence of ambient temperature values exceeding a threshold temperature value, constraining the first verified feature range proportional to ambient temperature values exceeding the threshold temperature value.

13. The method of claim 1, further comprising:
identifying dimensions of features of interest, previously verified at the optical inspection station, failing within the first verified feature range;
grouping neighboring features of interest into a cluster of features occupying a first region of the first verified feature range based on proximity of neighboring features to dimensions in the first verified feature range;
identifying a third dimension of a feature, in the features of interest, associated with a third unverified assembly unit and occupying a second region outside of the first region in the first nominal feature range;
rendering a second visual representation of the third unverified assembly unit on the display at the optical inspection station, the second visual representation indicating the third feature of interest on the third unverified assembly unit; and
rendering a prompt to verify the third feature of interest depicted in the second visual representation of the third unverified assembly unit.

14. The method of claim 1, wherein detecting the first constellation of features in the first image comprises:
dividing the first image into a set of image segments;
selecting a first image segment, in the set of image segments, corresponding to a region of interest associated with the optical inspection station, in a set of optical inspection stations, arranged along an assembly line;
extracting from the first image segment;
a set of visual features; and
a set of dimensions associated with the set of visual features; and
compiling the set of visual features and the set of dimensions into the first constellation of features representing physical features exhibited by the first verified assembly unit.

15. A method comprising, for each assembly unit in a sequence of assembly units of an assembly type at a particular assembly stage;
accessing an image captured at an optical inspection station and depicting the assembly unit;
extracting a set of feature values of a constellation of features from the image, the constellation of features representing physical features of the assembly type at the particular assembly stage, the set of feature values characterizing the constellation of features exhibited by the assembly unit;
characterizing differences between feature values of the constellation of features and corresponding verified feature ranges containing values of the constellation of features exhibited in assembly units, in the sequence of assembly units, previously verified;
identifying a subset of feature values, in the set of feature values, distinct from corresponding verified feature ranges;
rendering a visual representation of the assembly unit on a display at the optical inspection station; and
for each feature value in the subset of feature values:
indicating the feature, in the constellation of features, corresponding to the feature value in the first visual representation of the assembly unit rendered on the display;
prompting an operator to verify the feature;
in response to verification of the feature by the operator at the optical inspection station:
updating a verified feature range, corresponding to the feature, to contain the feature value; and
in response to rejection of the feature by the operator at the optical inspection station:
updating a rejection feature range, corresponding to the feature, contain the feature value.

16. The method of claim 15, further comprising, during a first assembly period:
accessing a first image captured at the optical inspection station and depicting a first assembly unit of the assembly type at the particular assembly stage;
extracting a first feature value of a first feature in a first constellation of features from the first image, the first constellation of features representing physical features of the assembly type at the particular assembly stage, the first feature value characterizing the first feature in the first constellation of features exhibited by the first assembly unit; and
in response to the first feature value falling within a first verified feature range, corresponding to the first feature, verifying the first assembly unit as a functional assembly unit.

17. The method of claim 15, further comprising, during a first assembly period:
accessing a first image captured at the optical inspection station and depicting a first assembly unit of the assembly type at the particular assembly stage;
extracting a first feature value of a first feature in a first constellation of features from the first image, the first constellation of features representing physical features of the assembly type at the particular assembly stage, the first feature value characterizing the first feature in the first constellation of features exhibited by the first assembly unit; and
in response to the first feature value outside of a first verified feature range, corresponding to the first feature, rejecting the first assembly unit as a non-functional assembly unit.

18. The method of claim 15, wherein identifying the subset of feature values, in the set of feature values, distinct from corresponding verified feature ranges comprises identifying the subset of feature values outside of verified bounds from corresponding verified feature ranges.

19. The method of claim 15, wherein identifying the subset of feature values, in the set of feature values, distinct from corresponding verified feature ranges comprises identifying the subset of feature values within verified bounds from corresponding verified feature ranges and offset from a cluster of feature values, in the set of feature values, previously verified at the optical inspection station.

20. A method comprising:
during a first assembly period:
accessing a first image captured at an optical inspection station and depicting a first unverified assembly unit at the particular assembly stage;
detecting a first constellation of features, in the first image, representing physical features exhibited by the first unverified assembly unit;
characterizing differences between dimensions of features in the first constellation of features and corresponding dimensions of features previously verified at the optical inspection station;
identifying a first dimension of a first feature of interest, in the first constellation of features, distinct from a nominal dimension range;
rendering a first visual representation of the first unverified assembly unit at an operator portal, the first visual representation indicating the first feature of interest on the first unverified assembly unit; and
in response to receiving verification of the first feature of interest on the first unverified assembly unit, updating the nominal dimension range to contain the first dimension; and
during a second assembly period following the first assembly period:
accessing a second image captured at the optical inspection station and depicting a second unverified assembly unit at the particular assembly stage;
detecting a second constellation of features, in the second image, representing physical features exhibited by the second unverified assembly unit; and
in response to a second dimension of the first feature of interest, in the second constellation of features, falling within the updated nominal feature range, verifying the first feature of interest depicted in the second unverified assembly unit.
